(19) United States
(12) Patent Application Publication
(10) Pub. No.: US 2025/0253552 A1
(43) Pub. Date: Aug. 7, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shunya TAKEUCHI, Mie (JP); Hajime MATSUI, Mie (JP)

(21) Appl. No.: 18/856,883

(22) PCT Filed: Apr. 3, 2023
(86) PCT No.: PCT/JP2023/013856

§ 371 Date: Oct. 15, 2024

(30) Foreign Application Priority Data
Apr. 21, 2022 (JP) 2022-069969

(51) Int. Cl. H01R 4/48

(52) U.S. Cl. CPC H01R 4/48

(57) ABSTRACT

A connector is to be connected to a first wire including a first core wire and extending in a front-rear direction, and provided with a first terminal to be connected to the first core wire, and a connector housing for accommodating the first terminal, the first wire being inserted into the connector housing. The first terminal includes a first terminal body and a first slide portion slidable in the front-rear direction in a state fit to the first terminal body from outside. The first terminal body includes a sandwiching portion for sandwiching the first core wire. The first slide portion includes a core wire insertion opening, a pressing portion for pressing the sandwiching portion, a guide portion disposed in a rear end part of the first slide portion, and a coupling portion continuously coupling the pressing portion and the guide portion in the front-rear direction.

### TECHNICAL FIELD

The present disclosure relates to a connector.

### BACKGROUND

Conventionally, a female terminal described in Japanese Patent Laid-Open Publication No. 2019-145208 (Patent Document 1) is known. This female terminal is provided with a terminal body including deformable upper and lower connection pieces extending in an extension direction, and a slide portion movable in the extension direction with respect to the terminal body. By moving the slide portion with a core wire of a wire disposed between the upper and lower connection pieces, upper and lower contact portions provided in the slide portion press the upper and lower connection pieces against the core wire and the terminal body and the wire can be electrically connected. Further, a connector provided with a connector housing for accommodating the female terminal and a rear holder to be attached to a rear end part of the connector housing in an extension direction is described as a connector provided with this female terminal in Patent Document 1 below.

### PRIOR ART DOCUMENT

### Patent Document

Patent Document 1: JP 2019-145208 A

### SUMMARY OF THE INVENTION

### Problems to be Solved

The above connector is manufactured as follows. First, the female terminal is accommodated into the connector housing, and the rear holder is assembled with the rear end part of the connector housing. In this state, the rear holder is held at a temporary locking position with respect to the connector housing. Then, the wire is inserted through an insertion hole of the rear holder and the core wire of the wire is inserted into the female terminal. At this time, the core wire is disposed between the upper and lower connection pieces. Subsequently, by moving the slide portion forward with respect to the terminal body, the upper and lower contact portions press the upper and lower connection pieces against the core wire and the female terminal and the wire are connected. Finally, the rear holder is moved to a complete locking position forward of the temporary locking position, and the female terminal is retained in the connector housing, whereby the manufacturing of the connector is completed.

It is considered to manufacture a connector similar to the above one by reducing a diameter of a wire without changing the connector housing and the rear holder in the above configuration. If the diameter of the wire is reduced, an interval in a vertical direction between the upper and lower contact portions for pressing the upper and lower connection pieces for sandwiching a core wire of the wire needs to be reduced. Thus, an inner diameter of the slide portion is reduced in the vertical direction as compared to the above configuration. Therefore, if the size of the slide portion is simply reduced without changing the configuration of the slide portion, the core wire may contact a rear end part of the slide portion to make it impossible to insert the core wire into the inside of the female terminal.

### Means to Solve the Problem

The present disclosure is directed to a connector to be connected to a first wire including a first core wire and extending in a front-rear direction, the connector being provided with a first terminal to be connected to the first core wire, and a connector housing for accommodating the first terminal, the first wire being inserted into the connector housing, the first terminal including a first terminal body and a first slide portion slidable in the front-rear direction in a state fit to the first terminal body from outside, the first terminal body including a sandwiching portion for sandwiching the first core wire, the first slide portion including a core wire insertion opening, the first core wire being inserted through the core wire insertion opening from behind, a pressing portion for pressing the sandwiching portion against the first core wire inserted through the core wire insertion opening, a guide portion disposed in a rear end part of the first slide portion, the guide portion being inclined inward of the first slide portion toward front, and a coupling portion continuously coupling the pressing portion and the guide portion in the front-rear direction, and the guide portion being disposed more outward of the first slide portion than the pressing portion.

### Effect of the Invention

According to the present disclosure, it is possible to provide a connector capable of guiding the insertion of a core wire into the inside of a terminal accommodated in a connector housing.

### BRIEF DESCRIPTION OF THE DRAWINGS

FIG. 1 is an exploded perspective view of a connector according to an embodiment.

FIG. 2 is a perspective view of the connector.

FIG. 3 is a perspective view of a first slide portion.

FIG. 4 is a perspective view of a second slide portion.

FIG. 5 is a back view of the first and second slide portions.

FIG. 6 is a section of the first slide portion.

FIG. 7 is a section along A-A of FIG. 6.

FIG. 8 is a section of the second slide portion.

FIG. 9 is a perspective view of a first terminal body.

FIG. 10 is a side view of a first terminal having the first slide portion disposed at a separation position with respect to the first terminal body.

FIG. 11 is a section along B-B of FIG. 10.

FIG. 12 is a side view of the first terminal having the first slide portion disposed at a pressing position with respect to the first terminal body.

FIG. 13 is a view of the first terminal when viewed from behind a rear holder.

FIG. 14 is a view of a second terminal when viewed from behind the rear holder.

FIG. 15 is a section showing a state where the first terminal having the first slide portion disposed at the separation position with respect to the first terminal body is accommodated in the connector housing.

FIG. 16 is a section showing a state where a first core wire is inserted into the inside of the first terminal from the state of FIG. 15.

FIG. 17 is a section showing a state where the first slide portion is moved to the pressing position with respect to the first terminal body and the rear holder is moved to a complete locking position from the state of FIG. 16.

FIG. 18 is a section showing a state where the second terminal having the second slide portion disposed at a separation position with respect to a second terminal body is accommodated in the connector housing.

FIG. 19 is a section showing a state where the second core wire is inserted into the inside of the second terminal from the state of FIG. 18.

FIG. 20 is a section showing a state where the second slide portion is moved to a pressing position with respect to the second terminal body and the rear holder is moved to the complete locking position from the state of FIG. 19.

FIG. 21 is an enlarged view of FIG. 15 showing a positional relationship of a guiding portion of the rear holder and a guide portion of the first terminal.

FIG. 22 is an enlarged view of FIG. 18 showing a positional relationship of the guiding portion of the rear holder and a rear end part of the second terminal.

FIG. 23 is a section of a connector according to a comparative example showing a positional relationship of a guiding portion of a rear holder and a rear end part of a third terminal.

### DETAILED DESCRIPTION TO EXECUTE THE INVENTION

### Description of Embodiments of Present Disclosure

First, embodiments of the present disclosure are listed and described.
(1) The connector of the present disclosure is a connector to be connected to a first wire including a first core wire and extending in a front-rear direction, and provided with a first terminal to be connected to the first core wire, and a connector housing for accommodating the first terminal, the first wire being inserted into the connector housing, the first terminal including a first terminal body and a first slide portion slidable in the front-rear direction in a state fit to the first terminal body from outside, the first terminal body including a sandwiching portion for sandwiching the first core wire, the first slide portion including a core wire insertion opening, the first core wire being inserted through the core wire insertion opening from behind, a pressing portion for pressing the sandwiching portion against the first core wire inserted through the core wire insertion opening, a guide portion disposed in a rear end part of the first slide portion, the guide portion being inclined inward of the first slide portion toward front, and a coupling portion continuously coupling the pressing portion and the guide portion in the front-rear direction, and the guide portion being disposed more outward of the first slide portion than the pressing portion.

If a diameter of the first core wire is reduced, the first slide portion provided with the pressing portion for pressing the first core wire against the sandwiching portion tends to become smaller in a direction orthogonal to the front-rear direction. Thus, it may become difficult to insert the first core wire into the inside of the first slide portion.

According to the above configuration, the guide portion is provided behind the pressing portion via the coupling portion. This guide portion is inclined inward of the first slide portion toward the front. Therefore, the insertion of the first core wire into the inside of the first slide portion is guided. Further, the guide portion is disposed more outward of the first slide portion than the pressing portion. Since the core wire insertion opening is easily made larger in the direction orthogonal to the front-rear direction in this way, the first core wire is easily inserted into the first slide portion.
(2) Preferably, the above connector is to be connected to a second wire including a second core wire and extending in the front-rear direction, and provided with a second terminal to be connected to the second core wire, a diameter of the second core wire is larger than a diameter of the first core wire, the second terminal is accommodated into the connector housing, the second wire is inserted into the connector housing, the second terminal includes a second terminal body and a second slide portion slidable in the front-rear direction in a state fit to the second terminal body from outside, the second terminal body includes a sandwiching portion for sandwiching the second core wire, and the second slide portion includes a core wire insertion opening, the second core wire being inserted through the core wire insertion opening from behind, and a pressing portion for pressing the second core wire inserted through the core wire insertion opening and disposed at a position of the sandwiching portion in the front-rear direction against the sandwiching portion.

According to this configuration, even if the diameter of the second core wire is larger than that of the first core wire, the connector connected to both the first wire including the first core wire and the second wire including the second core wire can be configured without changing the connector housing.
(3) Preferably, the second terminal body is the first terminal body.

According to this configuration, since the first terminal body can be used as the second terminal body, the second terminal body may not be newly manufactured. Therefore, the manufacturing cost of the connector can be reduced.
(4) Preferably, the first slide portion includes an outer wall portion disposed more outward of the first slide portion than the guide portion and extending in the front-rear direction, a rear end part of the guide portion and a rear end part of the outer wall portion are in contact, and the connector housing includes a locking portion facing the rear end part of the outer wall portion in the front-rear direction.

According to this configuration, a locking margin of the rear end part of the first slide portion and the connector housing can be increased by providing the outer wall portion. Further, since the rear end part of the guide portion and that of the outer wall portion are in contact, the deformation of the guide portion due to an external force or the like can be suppressed.
(5) Preferably, the first slide portion includes an intermediate wall portion sandwiched by the outer wall portion and the coupling portion and a folded portion continuously connecting the outer wall portion and the intermediate wall portion and folded into a U shape, and the intermediate wall portion is folded in contact with the outer wall portion.

According to this configuration, the first slide portion can be made larger in the direction orthogonal to the front-rear direction by providing the intermediate wall portion. In this way, even if the diameter of the first core wire is small, the first slide portion is easily configured in accordance with the size of the accommodating portion of the connector housing for accommodating the first terminal. Therefore, the rattling of the first terminal in the accommodating portion can be suppressed.
(6) Preferably, the first slide portion includes an inclined portion formed to be continuous with a front side of the pressing portion, and the inclined portion is inclined outward of the first slide portion toward the front and disposed more outward of the first slide portion than the pressing portion.

According to this configuration, when the first slide portion is slid forward with respect to the first terminal body, the sandwiching portion slides in contact with the inclined portion, thereby being easily guided inward of the first slide portion with respect to the pressing portion. Therefore, the first core wire is easily pressed against the sandwiching portion by the pressing portion.
(7) Preferably, the connector housing includes an inner housing for accommodating the first terminal and a rear holder to be assembled with a rear part of the inner housing, the first wire being inserted into the rear holder, the rear holder is locked to the inner housing at either one of a temporary locking position and a complete locking position disposed forward of the temporary locking position, and the rear holder is lockable at the complete locking position with the first core wire pressed against the sandwiching portion by the pressing portion.

According to this configuration, the connector can be made smaller in the front-rear direction with the first core wire pressed against the sandwiching portion by the pressing portion.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

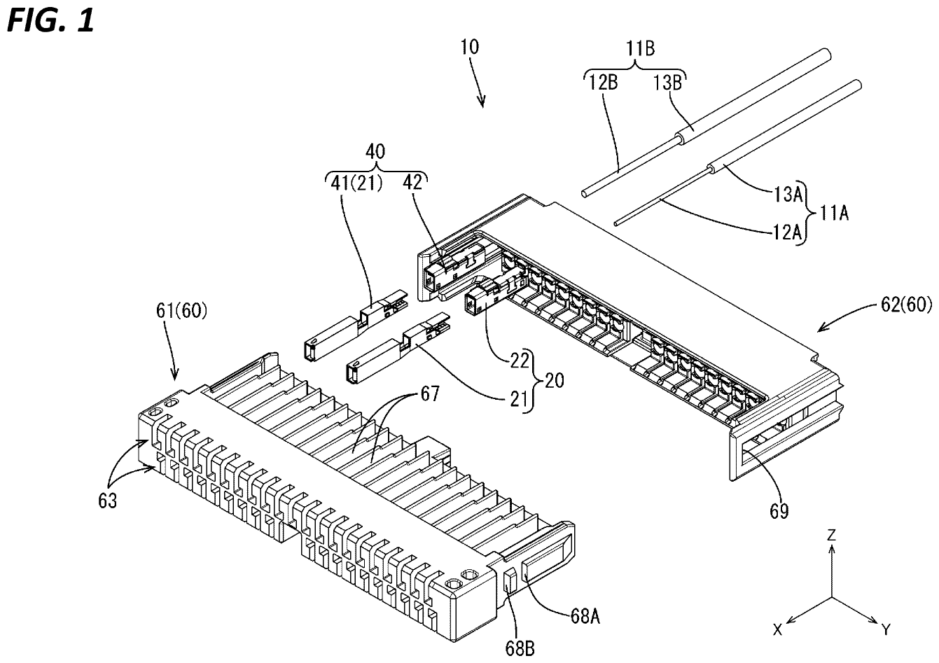

The embodiment of the present disclosure is described with reference to FIGS. 1 to 22. In the following description, a direction indicated by an arrow Z is an upward direction, a direction indicated by an arrow X is a forward direction and a direction indicated by an arrow Y is a leftward direction. Note that, for a plurality of identical members, only some members may be denoted by a reference sign and the other members may not be denoted by the reference sing.

### [Connector]

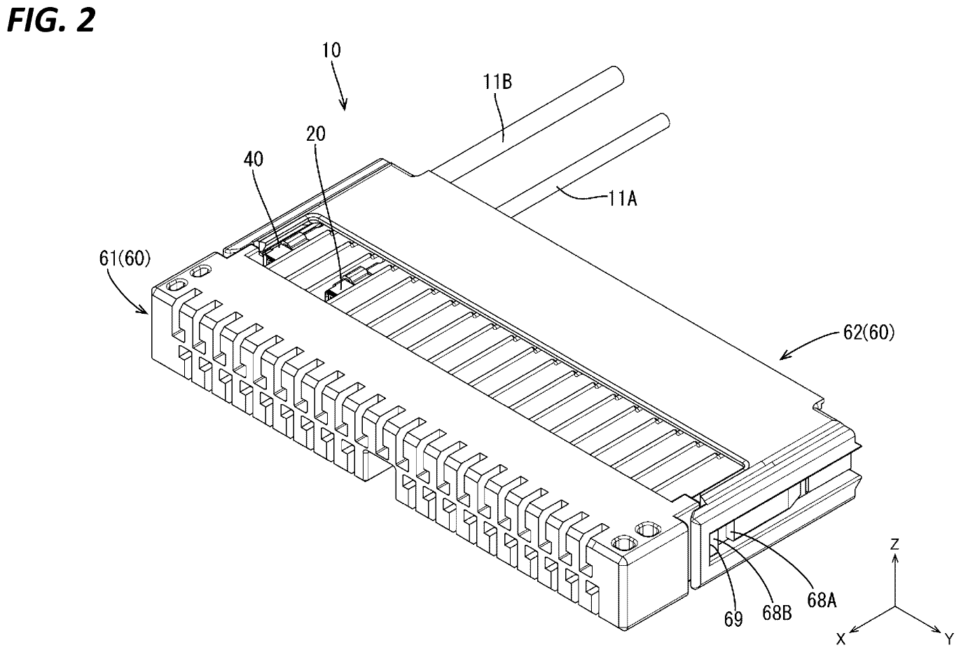

As shown in FIGS. 1 and 2, a connector 10 according to this embodiment is provided with first terminals 20 to be connected to ends of first wires 11A, second terminals 40 to be connected to ends of second wires 11B, and a connector housing 60 for accommodating the first and second terminals 20, 40, the first and second wires 11A, 11B being inserted into the connector housing 60.

### [First Wire]

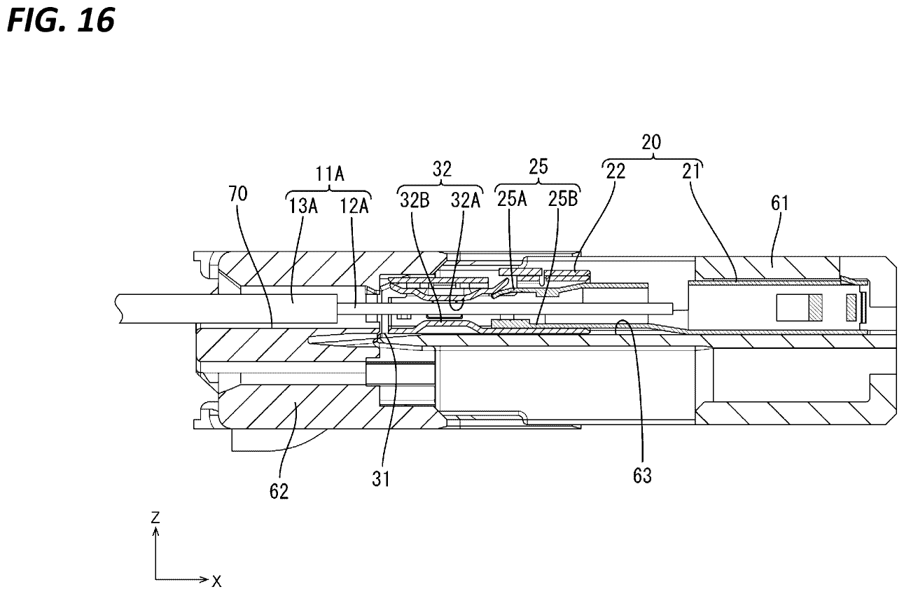

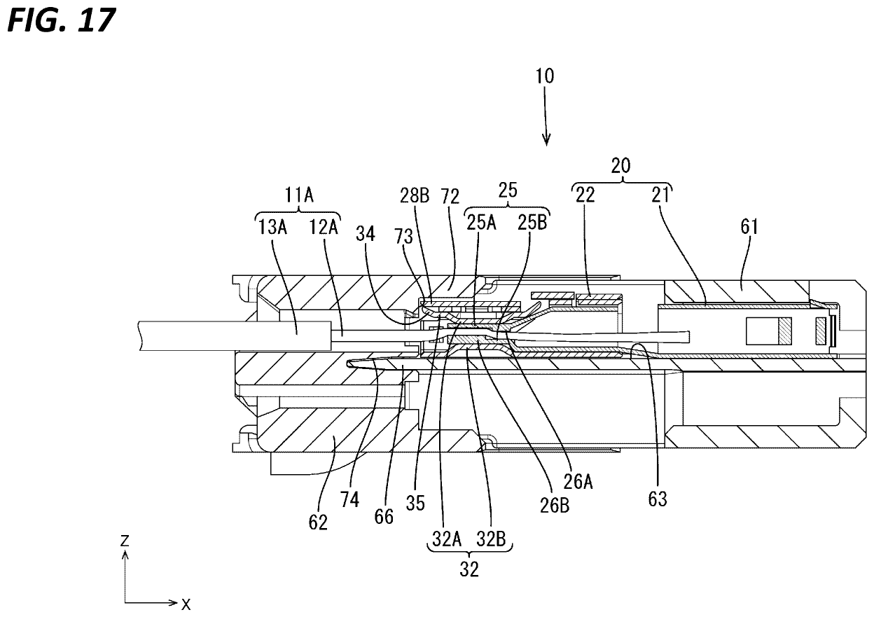

As shown in FIGS. 16 and 17, the first core wire 11A is disposed to extend in the front-rear direction. The first core wire 11A is provided with a first core wire 12A and a first insulation coating 13A covering the outer peripheral surface of the first core wire 12A. The first core wire 12A is made of electrically conductive metal and is a stranded wire formed by twisting a plurality of metal wires or a single core wire made of one metal wire. The first insulation coating 13A is made of insulating synthetic resin. The first core wire 12A is exposed in a front end part of the first core wire 11A.

### [Second Wire]

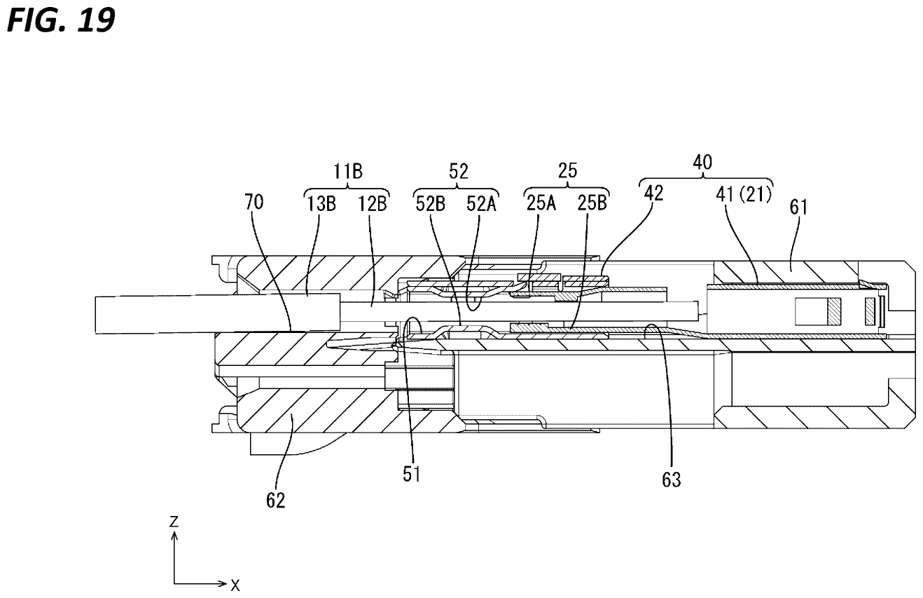

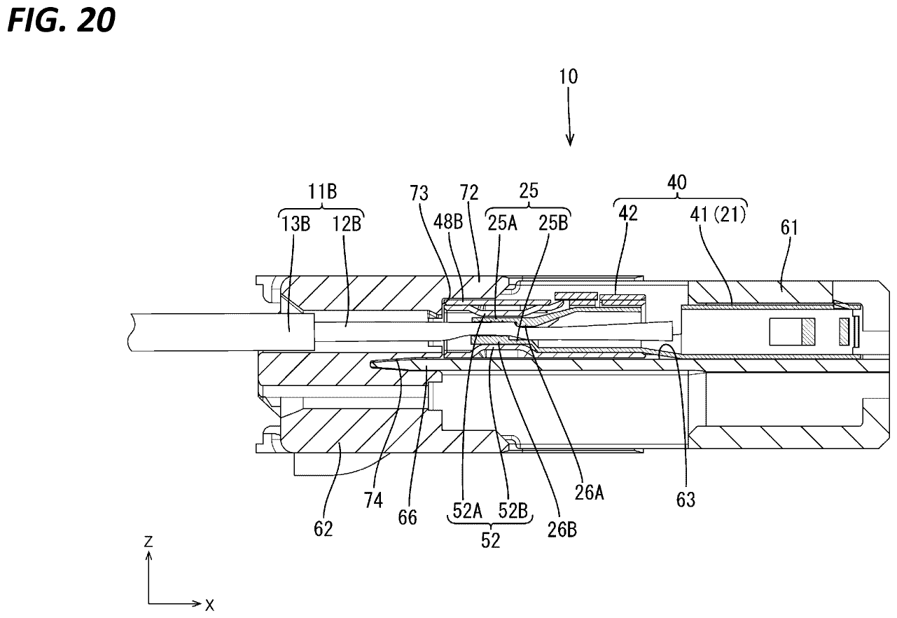

As shown in FIGS. 19 and 20, the second wire 11B is disposed to extend in the front-rear direction. The second wire 11B is provided with a second core wire 12B and a second insulation coating 13B covering the outer peripheral surface of the second core wire 12B. The second core wire 12B is made of electrically conductive metal and is a stranded wire formed by twisting a plurality of metal wires or a single core wire made of one metal wire. The second insulation coating 13B is made of insulating synthetic resin. The second core wire 12B is exposed in a front end part of the second wire 11B. As shown in FIG. 1, a diameter of the second core wire 12B is larger than that of the first core wire 12A. An outer diameter of the second insulation coating 13B is larger than that of the first insulation coating 13A. Note that the outer diameter of the second insulation coating 13B may be equal to that of the first insulation coating 13A.

### [First Terminal]

The first terminal 20 is made of electrically conductive metal. As shown in FIG. 1, the first terminal 20 is provided with a first terminal body 21 and a first slide portion 22 movable in the front-rear direction with respect to the first terminal body 21. The first terminal body 21 and the first slide portion 22 are formed, such as by press-working an electrically conductive metal plate material. An arbitrary metal such as copper, copper alloy, aluminum, aluminum alloy or stainless steel can be appropriately selected as a metal constituting the first terminal body 21 and the first slide portion 22 if necessary. Plating layers may be formed on surfaces of the first terminal body 21 and the first slide portion 22. An arbitrary metal such tin, nickel or silver can be appropriately selected can be selected as a metal constituting the plating layers.

### [First Terminal Body]

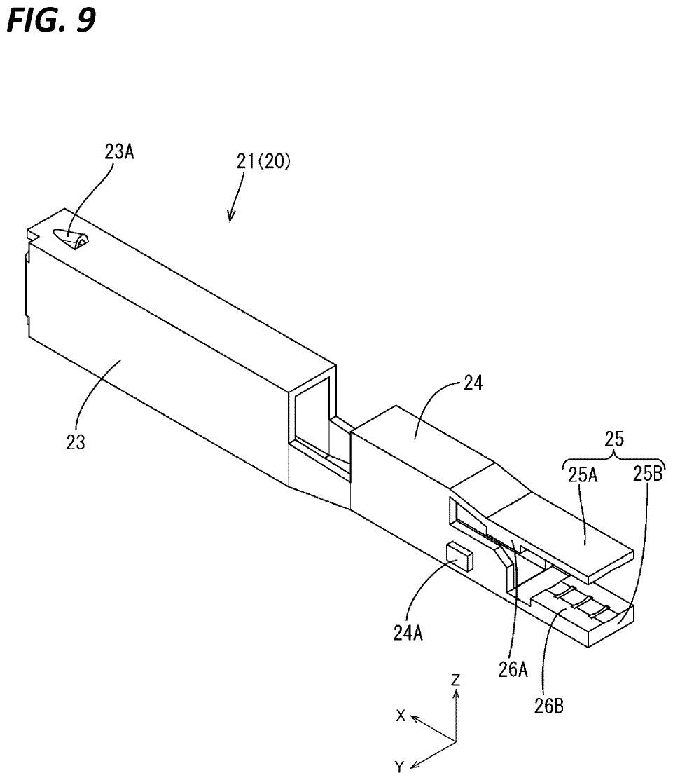

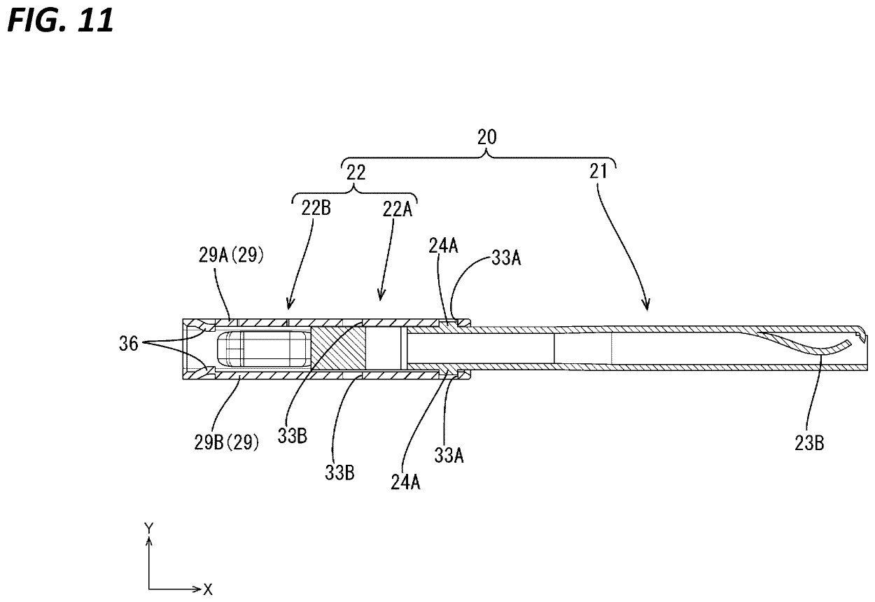

As shown in FIG. 9, a front part of the first terminal body 21 serves as a connecting tube portion 23 in the form of a rectangular tube extending in the front-rear direction. A locking lance 23A having a chevron shape is formed to project upward on a front side of the upper wall of the connecting tube portion 23. As shown in FIG. 11, a resilient contact piece 23B is provided inside the connecting tube portion 23. A plate-like mating terminal (not shown) is inserted into the inside of the connecting tube portion 23. The mating terminal inserted into the connecting tube portion 23 contacts the resilient contact piece 23B.

As shown in FIG. 9, a base portion 24 in the form of a rectangular tube is provided behind the connecting tube portion 23. Locking projections 24A projecting outward are formed on side walls of the base portion 24. A sandwiching portion 25 is provided in a rear end part of the base portion 24.

### [Sandwiching Portion]

The sandwiching portion 25 includes an upper connection piece 25A extending rearward from a rear end part of the upper wall of the base portion 24 and a lower connection piece 25B extending rearward from a rear end of the lower wall of the base portion 24. The upper and lower connection pieces 25A, 25B have a shape elongated in the front-rear direction and lengths thereof in the front-rear direction are nearly equal. The upper and lower connection pieces 25A, 25B are formed to be resiliently deformable in the vertical direction with a rear end part of the base portion 24 as a fulcrum. As shown in FIG. 17, the lower surface of the upper connection piece 25A and the upper surface of the lower connection piece 25B can sandwich the first core wire 12A and electrically connect the first core wire 11A and the first terminal body 21.

As shown in FIG. 9, the lower surface of the upper connection piece 25A is provided with an upper holding protrusion 26A projecting downward at a position forward of a rear end part. A rear end part of the upper surface of the lower connection piece 25B is provided with a lower holding protrusion 26B projecting upward. The upper and lower holding protrusions 26A, 26B are provided at positions shifted in the front-rear direction.

### [First Slide Portion]

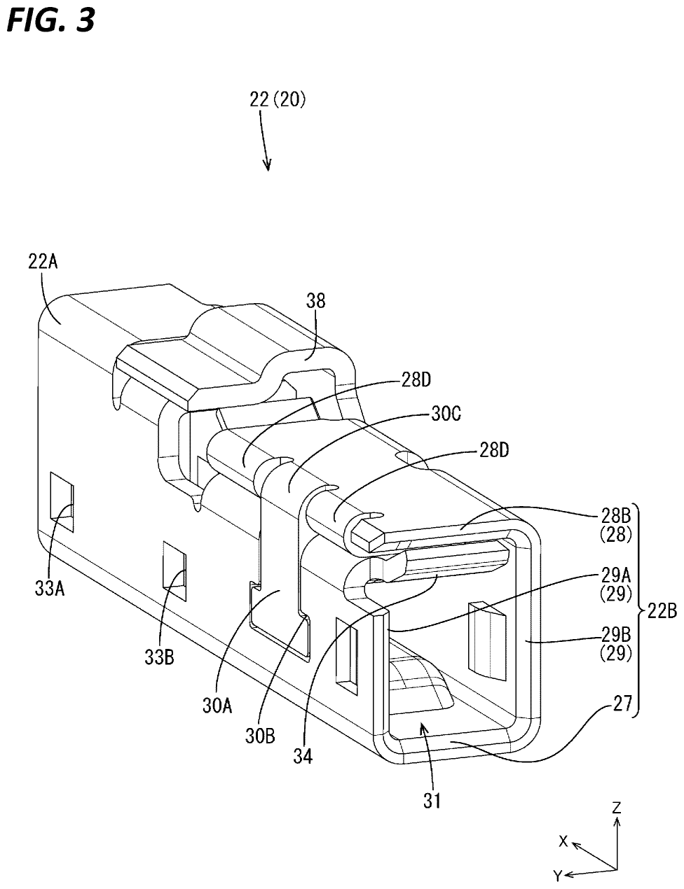

As shown in FIG. 3, the first slide portion 22 is in the form of a rectangular tube extending in the front-rear direction. The first slide portion 22 includes a front tube portion 22A and a rear tube portion 22B connected to a rear side of the front tube portion 22A. The rear tube portion 22B is smaller than the front tube portion 22A in the vertical direction.

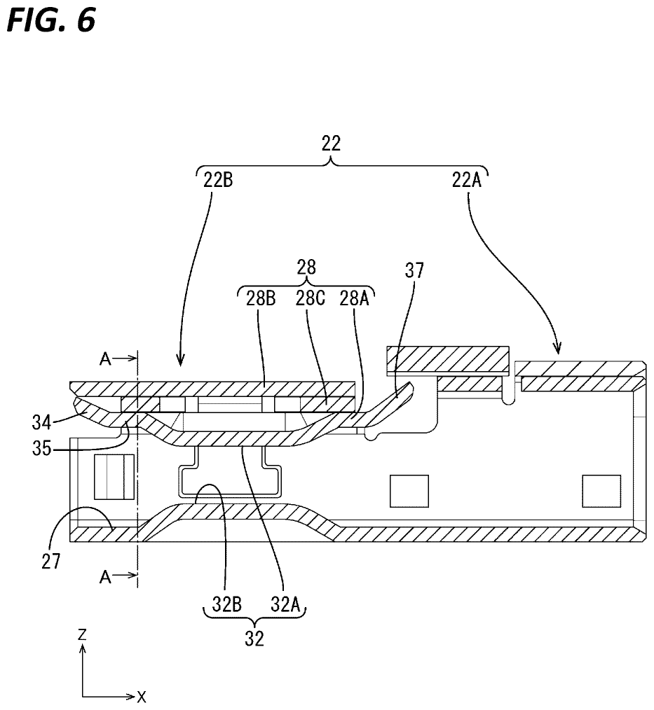

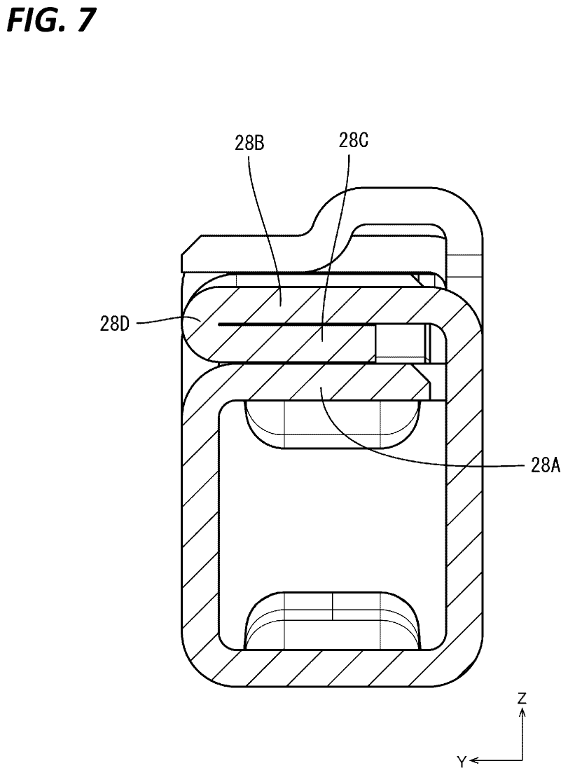

As shown in FIG. 3, the rear tube portion 22B includes a bottom wall portion 27, a first ceiling wall portion 28 facing the bottom wall portion 27, a first side wall portion 29A connecting the left end edge of the bottom wall portion 27 and that of the first ceiling wall portion 28 and a second side wall portion 29B connecting the right end edge of the bottom wall portion 27 and that of the first ceiling wall portion 28. The first and second side wall portions 29A, 29B are called the side wall portions 29 unless particularly distinguished. As shown in FIG. 6, the first ceiling wall portion 28 has a triply overlapped part of the metal plate material. In particular, the first ceiling wall portion 28 includes an inner wall portion 28A disposed inside the rear tube portion 22B, an outer wall portion 28B disposed outside the rear tube portion 22B and intermediate wall portions 28C sandwiched by the inner wall portion 28A and the outer wall portion 28B. The intermediate wall portions 28C are disposed on front and rear sides of the rear tube portion 22B. As shown in FIG. 7, the intermediate wall portion 28C is formed by closely bending the metal plate material constituting the outer wall portion 28B. In other words, the left end edge of the outer wall portion 28B and those of the intermediate wall portions 28C are continuously connected by folded portions 28D. The folded portion 28D is formed by bending the metal plate material by 180° and U-shaped when viewed from the front-rear direction.

As shown in FIG. 3, the rear tube portion 22B includes a locking protrusion 30A formed to be continuous with the outer wall portion 28B and a locking recess 30B to be locked to the locking protrusion 30A. The locking protrusion 30A is formed by bending the metal plate material constituting the outer wall portion 28B by 90°. In other words, the left end edge of the outer wall portion 28B and the upper end edge of the locking protrusion 30A are continuously connected by a bent portion 30C. The bent portion 30C is L-shaped when viewed from the front-rear direction. The locking protrusion 30A is inverted T-shaped when viewed from left. The locking recess 30B is formed in the first side wall portion 29A and shaped to be able to accommodate the locking protrusion 30A. The bent portion 30C is disposed side by side with the folded portions 28D in the front-rear direction. More particularly, the bent portion 30C is disposed between the front and rear folded portions 28D.

The shape of the rear tube portion 22B is retained by locking the locking protrusion 30A and the locking recess 30B. Since the bent portion 30C is disposed side by side with the folded portions 28D, the intermediate wall portions 28C and the locking protrusion 30A can be formed by forming a slit in the metal plate material constituting the outer wall portion 28B and bending the slitted part. Therefore, the intermediate wall portions 28C can be formed by utilizing the metal plate material without waste.

### [Core Wire Insertion Opening]

As shown in FIG. 3, a rear end part of the rear tube portion 22B of the first slide portion 22 is formed with a core wire insertion opening 31 for allowing the first core wire 12A to be inserted into the inside of the first slide portion 22. As shown in FIG. 16, the first core wire 12A inserted through the core wire insertion opening 31 is disposed to extend in the front-rear direction between the sandwiching portions 25.

### [Pressing Portion]

As shown in FIG. 6, the rear tube portion 22B of the first slide portion 22 includes a pressing portion 32. The pressing portion 32 includes an upper pressing portion 32A projecting downward from the lower surface of the inner wall portion 28A and a lower pressing portion 32B projecting upward from the upper surface of the bottom wall portion 27. As shown in FIG. 17, the pressing portion 32 presses the sandwiching portion 25, whereby the first core wire 12A is sandwiched by the sandwiching portion 25. In this way, the first wire 11A and the first slide portion 22 (first terminal 20) are electrically connected.

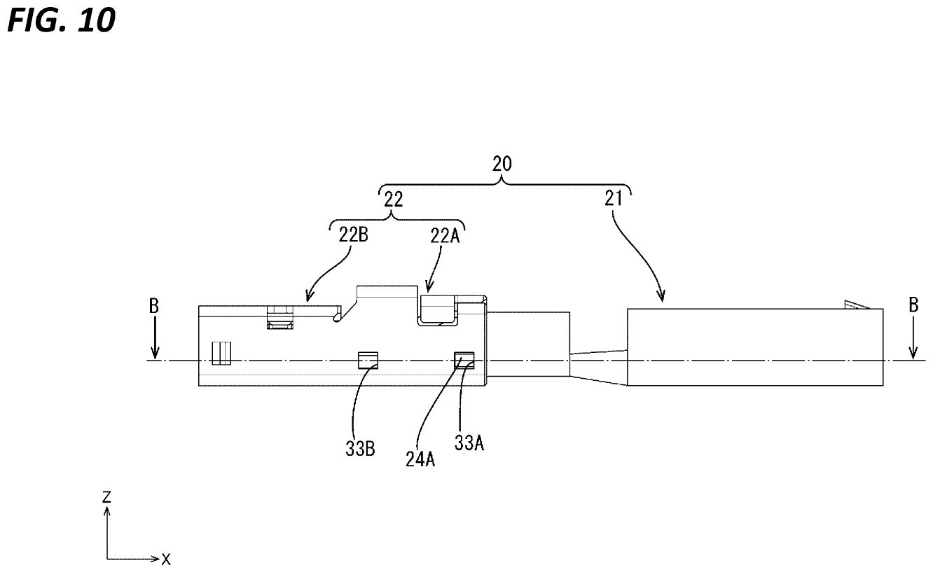

As shown in FIGS. 10 to 12, temporary lock receiving portions 33A are open at positions near a front end part in the side walls of the front tube portion 22A of the first slide portion 22. Further, complete lock receiving portions 33B are open at positions rearward of the temporary lock receiving portions 33A in the side walls of the front tube portion 22A of the first slide portion 22. The temporary lock receiving portions 33A and the complete lock receiving portions 33B are resiliently lockable to the locking projections 22A of the first terminal body 21.

As shown in FIGS. 10 and 11, with the locking projections 24A of the first terminal body 21 and the temporary lock receiving portions 33A of the first slide portion 22 locked, the first slide portion 22 is held at a separation position with respect to the first terminal body 21. In this state, as shown in FIG. 16, the pressing portion 32 of the first slide portion 22 is disposed behind the rear end edge of the sandwiching portion 25 of the first terminal body 21. Further, in this state, an interval between the upper and lower connection pieces 25A, 25B is set to be larger than the diameter of the first core wire 12A.

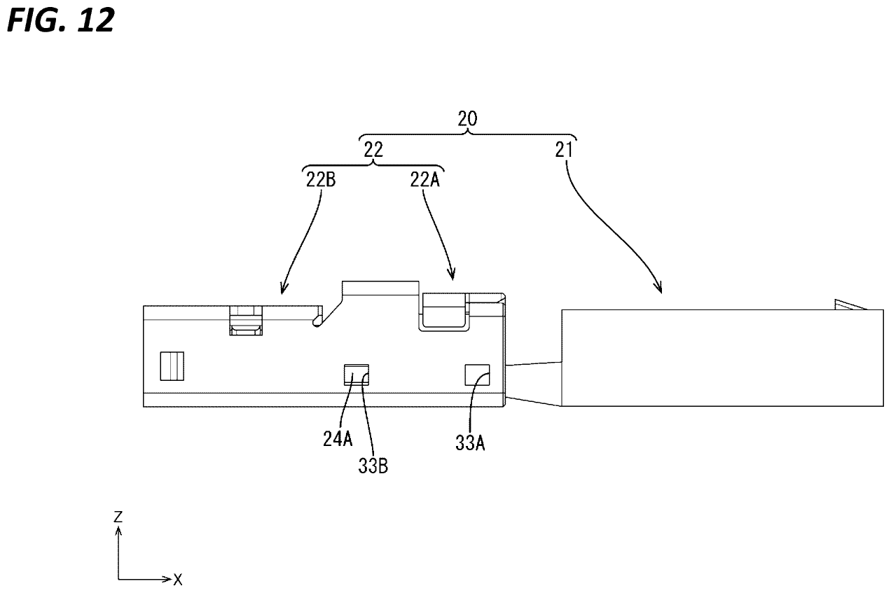

As shown in FIG. 12, with the locking projections 24A of the first terminal body 21 and the complete lock receiving portions 33B of the first slide portion 22 locked, the first slide portion 22 is held at a pressing position with respect to the first terminal body 21. In this state, as shown in FIG. 17, the upper pressing portion 32A of the first slide portion 22 is in contact with the upper surface of the upper connection piece 25A of the first terminal body 21 from above. Further, the lower pressing portion 32B of the first slide portion 22 is in contact with the lower surface of the lower connection piece 25B of the first terminal body 21 from below.

With the first slide portion 22 held at the pressing position with respect to the first terminal body 21, the upper pressing portion 32A presses the upper connection piece 25A from above, whereby the upper connection piece 25A is resiliently deformed downward. Further, the lower pressing portion 32B presses the lower connection piece 25B from below, whereby the lower connection piece 25B is resiliently deformed upward. In this way, the first core wire 12A is disposed to extend in the front-rear direction in a space between the upper and lower connection pieces 25A, 25B, and the first core wire 12A is sandwiched in the vertical direction by the resiliently deformed upper and lower connection pieces 25A, 25B with the first slide portion 22 held at the pressing position with respect to the first terminal body 21.

With the first slide portion 22 held at the pressing position with respect to the first terminal body 21, the upper holding protrusion 26A of the upper connection piece 25A presses the first core wire 12A from above and the lower holding protrusion 26B of the lower connection piece 25B presses the first core wire 12A from below. As just described, the first core wire 12A is held in a state bent in the vertical direction by being pressed from above by the upper holding protrusion 26A and pressed from below by the lower holding protrusion 26B disposed at the position shifted in the front-rear direction from the upper holding protrusion 26A. In this way, a holding force for holding the first core wire 12A in the first terminal body 21 can be improved.

### [Guide Portion]

As shown in FIG. 6, the rear tube portion 22B of the first slide portion 22 includes a guide portion 34. The guide portion 34 is provided in a rear end part of the inner wall portion 28A in this embodiment. The guide portion 34 is inclined inward (downward in this embodiment) of the first slide portion 22 toward the front. A rear end part of the guide portion 34 is in contact with a rear end part of the outer wall portion 28B. A front end part of the guide portion 34 is connected to a rear end part of the pressing portion 32 (upper pressing portion 32A in this embodiment) via a coupling portion 35. The coupling portion 35 is a part of the inner wall portion 28A and continuously connects the guide portion 34 and the upper pressing portion 32A in the front-rear direction. The guide portion 34 is disposed more outward (upward in this embodiment) of the first slide portion 22 than the upper pressing portion 32A. The first core wire 12A slides in contact with the guide portion 34, thereby being guided into the inside of the first slide portion 22.

As shown in FIG. 11, a pair of introducing portions 36 projecting inward of the first slide portion 22 are provided on the side wall portions 29 at positions near the rear end part of the rear tube portion 22B. The introducing portion 36 is inclined to be located inward of the first slide portion 22 toward the front. The first core wire 12A slides in contact with the introducing portions 36, thereby being guided into the inside of the first slide portion 22.

### [Inclined Portion]

As shown in FIG. 6, the first slide portion 22 includes an inclined portion 37 disposed in front of the pressing portion 32 (upper pressing portion 32A in this embodiment). The inclined portion 37 is disposed in a front end part of the inner wall portion 28A. The inclined portion 37 is inclined outward (upward in this embodiment) of the first slide portion 22 toward the front. The inclined portion 37 is formed continuously with the upper pressing portion 32A in the front-rear direction. The inclined portion 37 is disposed to be higher than the upper pressing portion 32A. When the first slide portion 22 moves from the separation position to the pressing position with respect to the first terminal body 21, the inclined portion 37 slides in contact with the rear end part of the upper connection piece 25A of the first terminal body 21 and guides the upper connection piece 25A downward of the upper pressing portion 32A.

As shown in FIG. 3, the front tube portion 22A of the first slide portion 22 is provided with a jig contact portion 38 projecting upward from the upper wall. Although not shown, the first slide portion 22 is movable forward by bringing a jig into contact with the jig contact portion 38 from behind and pushing the jig contact portion 38 forward.

### [Second Terminal, Second Terminal Body]

The second terminal 40 is made of electrically conductive metal. As shown in FIG. 1, the second terminal 40 is provided with a second terminal body 41 and a second slide portion 42 movable in the front-rear direction with respect to the second terminal body 41, similarly to the first terminal 20. In this embodiment, the second terminal body 41 is the first terminal body 21.

### [Second Slide Portion]

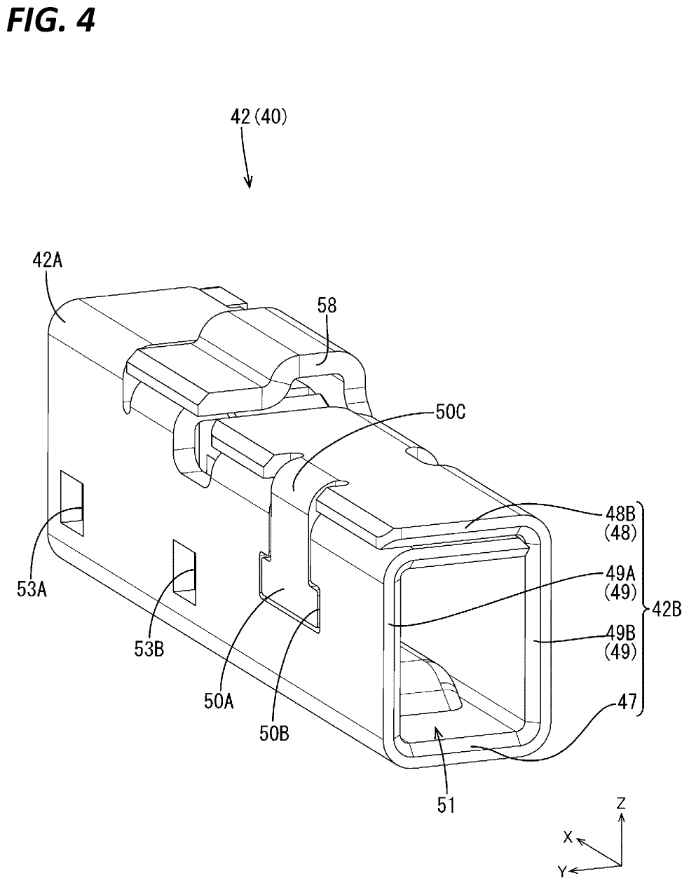

Since the second slide portion 42 is configured substantially similarly to the first slide portion 22, the same terms are used for the same members as those of the first slide portion 22 and these members are not described in detail. As shown in FIG. 4, the second slide portion 42 includes a front tube portion 42A and a rear tube portion 42B. Similarly to the front tube portion 22A of the first slide portion 22, the front tube portion 42A of the second slide portion 42 is provided with temporary lock receiving portions 53A, complete lock receiving portions 53B and a jig contact portion 58.

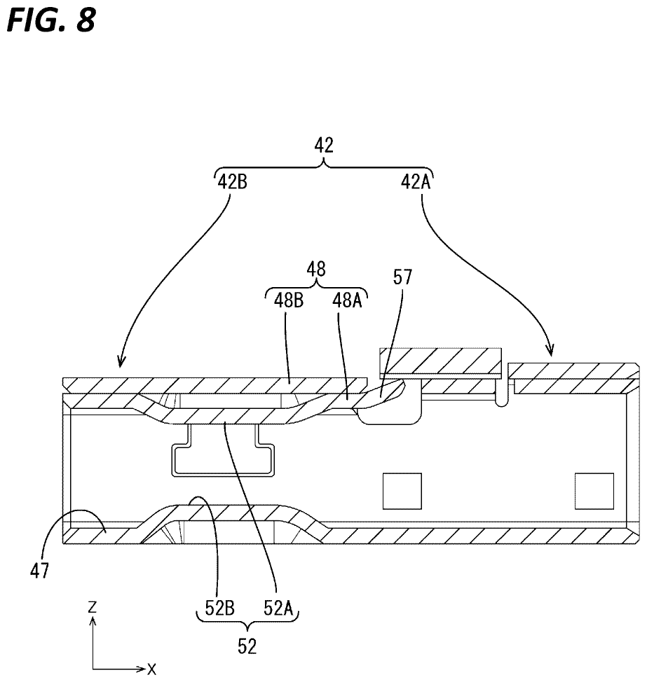

The rear tube portion 42B of the second slide portion 42 includes a bottom wall portion 47, a second ceiling wall portion 48 facing the bottom wall portion 47, a first side wall portion 49A (side wall portion 49) connecting the left end edge of the bottom wall portion 47 and that of the second ceiling wall portion 48 and a second side wall portion 49B (side wall portion 49) connecting the right end edge of the bottom wall portion 47 and that of the second ceiling wall portion 48. As shown in FIG. 8, the second ceiling wall portion 48 is configured by doubly overlapping a metal plate material. In particular, the second ceiling wall portion 48 includes an inner wall portion 48A disposed inside the rear tube portion 42B and an outer wall portion 48B disposed outside the rear tube portion 42B by being overlapped on the inner wall portion 48A. That is, the second ceiling wall portion 48 does not include the intermediate wall portions 28C provided in the first ceiling wall portion 28 of the first slide portion 22.

As shown in FIG. 4, the rear tube portion 42B of the second slide portion 42 includes a locking protrusion 50A formed to be continuous with the outer wall portion 48B and a locking recess 50B to be locked to the locking protrusion 50A. The left end edge of the outer wall portion 48B and the upper end edge of the locking protrusion 50A are continuously connected by a bent portion 50C. The shape of the rear tube portion 42B is retained by locking the locking protrusion 50A and the locking recess 50B.

A rear end part of the rear tube portion 42B of the second slide portion 42 is formed with a core wire insertion opening 51 for allowing the second core wire 12B to be inserted into the inside of the second slide portion 42.

As shown in FIG. 8, the rear tube portion 42B of the second slide portion 42 includes a pressing portion 52. The pressing portion 52 includes an upper pressing portion 52A and a lower pressing portion 52B. The second slide portion 42 includes an inclined portion 57 formed to be continuous with a front side of the upper pressing portion 52A.

### [Size Comparison of First Slide Portion and Second Slide Portion]

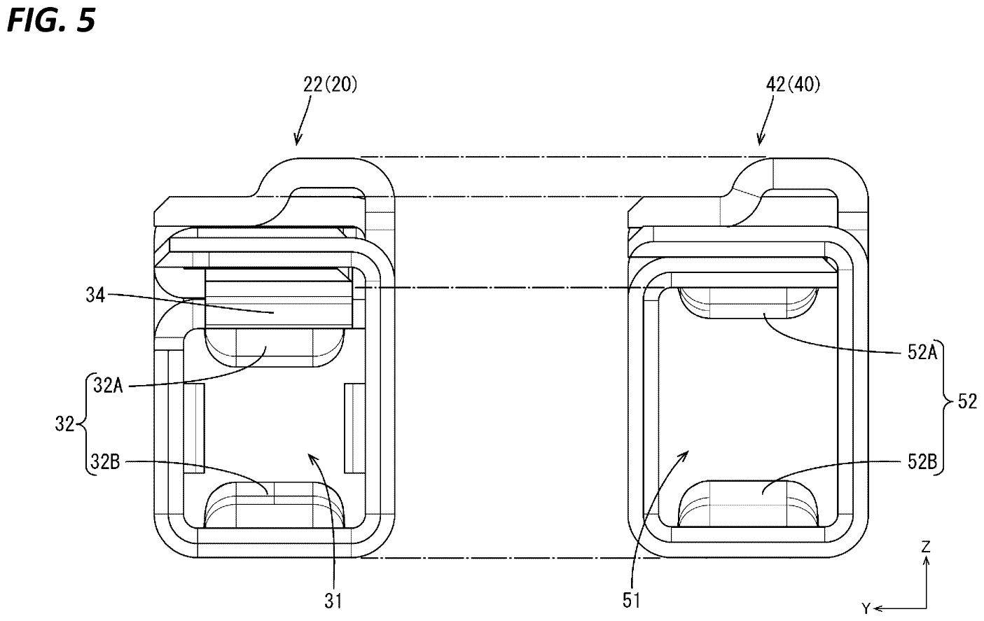

As shown in FIG. 1, the diameter of the second core wire 12B is larger than that of the first core wire 12A. Thus, as shown in FIG. 5, an interval in the vertical direction between the upper and lower pressing portions 52A, 52B of the second slide portion 42 is larger than that between the upper and lower pressing portions 32A, 32B of the first slide portion 22. Associated with this, the core wire insertion opening 51 of the second terminal 40 is larger than the core wire insertion opening 31 of the first terminal 20 in the vertical direction.

### [Connector Housing, Inner Housing]

In this embodiment, the connector housing 60 is provided with an inner housing 61 and a rear holder 62 to be attached to a rear part of the inner housing 61 as shown in FIG. 2. As shown in FIG. 1, the inner housing 61 has a rectangular parallelepiped shape short in the vertical direction and long in a lateral direction. The inner housing 61 is made of insulating synthetic resin. The inner housing 61 extends in the front-rear direction and includes a plurality of accommodating portions 63 each for accommodating the first terminal 20 or the second terminal 40. The accommodating portions 63 are aligned at intervals in the lateral direction and overlapped in two upper and lower stages. The respective accommodating portions 63 formed in the upper stage and those formed in the lower stages are disposed at laterally shifted positions. Note that the number and relative arrangement of the accommodating portions 63 can be changed as appropriate.

The front end of the accommodating portion 63 is open forward, and the mating terminal is insertable thereinto. The rear end of the accommodating portion 63 is open rearward and the first or second terminal 20, 40 can be accommodated thereinto from behind.

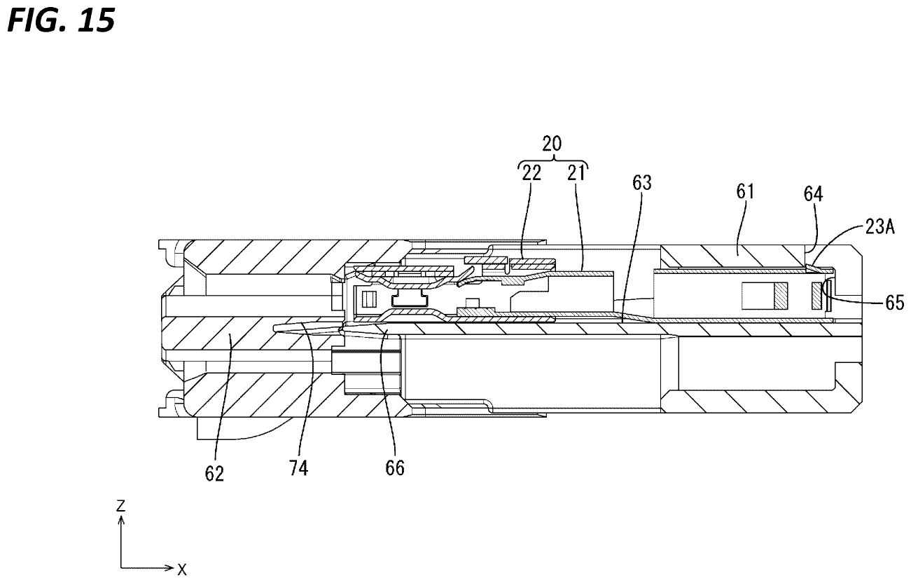

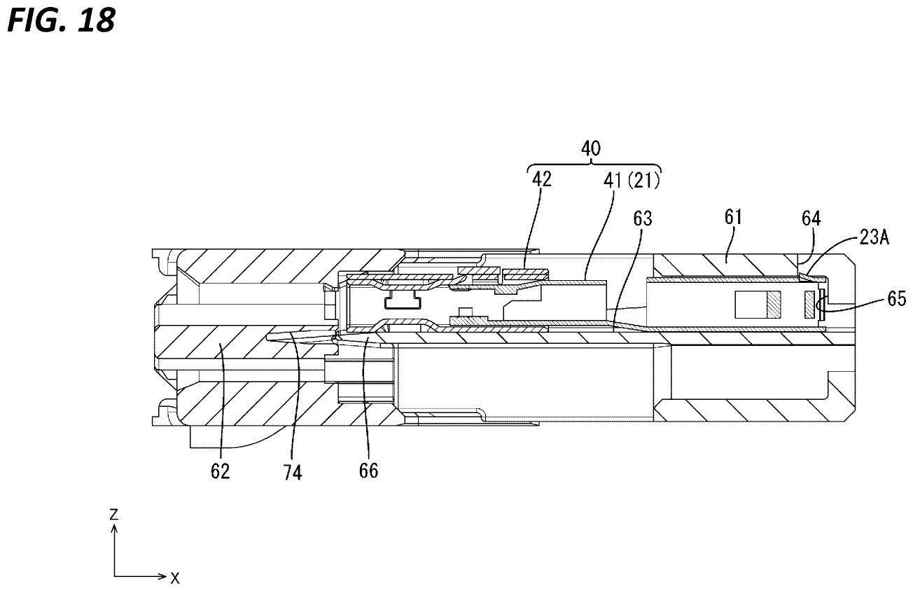

As shown in FIGS. 15 and 18, the inner housing 61 includes lance receiving portions 64, each of which is locked to the locking lance 23A with the first or second terminal 20, 40 accommodated in the accommodating portion 63. By locking the locking lance 23A and the lance receiving portion 64, the first or second terminal 20, 40 is retained in the accommodating portion 63 not to come out rearward.

A front end part of the inner housing 61 is formed with front stop portions 65. The first or second terminal 20, 40 comes into contact with the front stop portion 65 so as not to come out forward of the inner housing 61 when being inserted into the inside of the accommodating portion 63.

The inner housing 61 includes a separation wall 66 partitioning between the accommodating portions 63 formed in the upper stage and those formed in the lower stage. As shown in FIG. 1, the inner housing 61 includes partition walls 67 partitioning between the respective accommodating portions 63 in the lateral direction. The first or second terminal 20, 40 accommodated in each accommodating portion 63 is electrically insulated from the first or second terminal(s) 20, 40 adjacent in the lateral direction by this partition wall 67.

Temporary lock portions 68A projecting outward are provided at positions near rear end parts of both left and right side walls of the inner housing 61. Complete lock portions 68B are provided to project outward at positions forward of the temporary lock portions 68A on the both left and right side walls of the inner housing 61.

### [Rear Holder]

The rear holder 62 is in the form of a box open forward. The rear holder 62 is made of insulating synthetic resin. As shown in FIG. 2, the rear holder 62 is fit to a rear half part of the inner housing 61 from outside. Lock receiving portions 69 are provided at positions near front end parts of the both left and right side walls of the rear holder 62. The lock receiving portion 69 is substantially gate-shaped.

The rear holder 62 is held at a temporary locking position with respect to the inner housing 61 by locking the temporary lock portions 68A of the inner housing 61 and the lock receiving portions 69 of the rear holder 62. Further, the rear holder 62 is held at a complete locking position with respect to the inner housing 61 by locking the complete lock portions 68B of the inner housing 61 and the lock receiving portions 69 of the rear holder 62.

As shown in FIGS. 16 and 19, the rear holder 62 is provided with insertion holes 70 at positions corresponding to the respective accommodating portions 63 of the inner housing 61. That is, a plurality of the insertion holes 70 are aligned in the lateral direction and provided side by side in two upper and lower stages. An inner diameter of the insertion hole 70 is set to be equal to or slightly larger than the outer diameter of the second insulation coating 13B of the second wire 11B. The first or second wire 11A, 11B is inserted through the insertion hole 70.

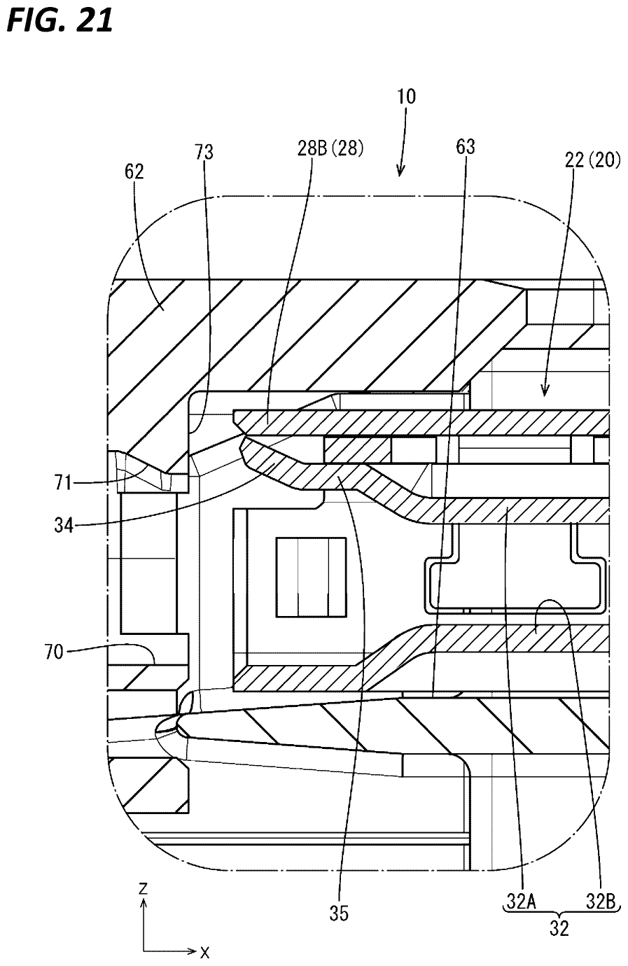

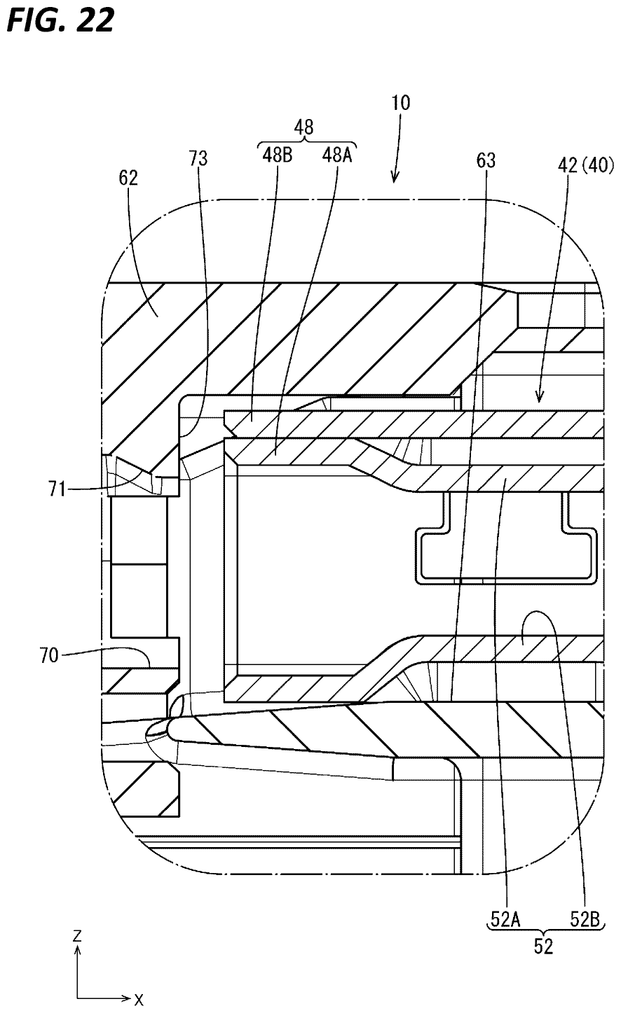

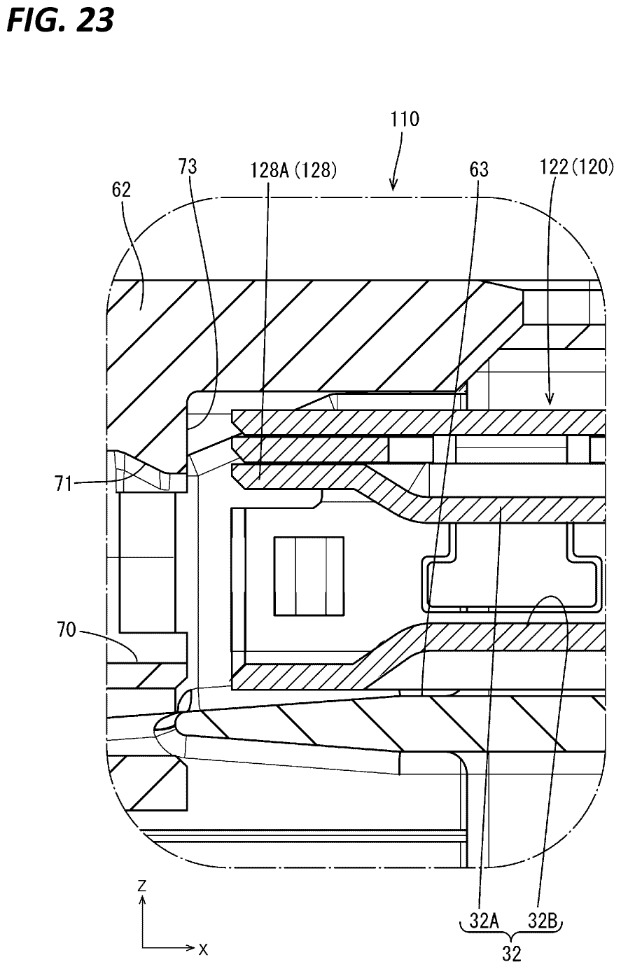

As shown in FIGS. 21 and 22, the rear holder 62 includes guiding portions 71 in the inner walls of the insertion holes 70. The guiding portion 71 is disposed on an upper side of the front end of the insertion hole 70. The guiding portion 71 is formed into a curved surface located inward of the insertion hole 70 toward the front. The first core wire 12A slides in contact with the guiding portion 71, thereby more easily entering the inside of the first slide portion 22. The second core wire 12B slides in contact with the guiding portion 71, thereby more easily entering the inside of the second slide portion 42.

### [Locking Portion]

As shown in FIGS. 17 and 20, the rear holder 62 is provided with a receptacle 72, which is open forward and into which the inner housing 61 is fit. The rear holder 62 includes locking portions 73 in a rear end part of the receptacle 72. The locking portion 73 is facing the outer wall portion 28B of the first terminal 20 or the outer wall portion 48B of the second terminal 40 in the front-rear direction. The locking portion 73 retains the first or second terminal 20, 40 in the accommodating portion 63 so as not to come out rearward by locking the outer wall portion 28B of the first terminal 20 or the outer wall portion 48B of the second terminal 40 in the front-rear direction.

A separation wall receiving portion 74 is provided near a center in the vertical direction of the rear holder 62. This separation wall receiving portion 74 is open forward, and a vertical dimension of the opening is set to be equal to or somewhat larger than a thickness in the vertical direction of the separation wall 66 of the inner housing 61.

As shown in FIGS. 15 and 18, the separation wall receiving portion 74 is located behind the rear end edge of the separation wall 66 of the inner housing 61 with the rear holder 62 held at the temporary locking position with respect to the inner housing 61. As shown in FIGS. 17 and 20, the separation wall 66 of the inner housing 61 is fit in the opening of the separation wall receiving portion 74 of the rear holder 62 with the rear holder 62 held at the complete locking position with respect to the inner housing 61. In this way, the rear holder 62 is suppressed from being shifted in position in the vertical direction with respect to the inner housing 61.

[Insertion of Second Core Wire into Second Slide Portion]

As shown in FIG. 22, with the second terminal 40 accommodated in the accommodating portion 63, a rear end part of the second ceiling wall portion 48 of the second slide portion 42 is disposed to face the locking portion 73 in the front-rear direction. Further, when the insertion hole 70 of the rear holder 62 disposed behind the accommodating portion 63 accommodating the second terminal 40 is viewed from behind, the rear end part of the second ceiling wall portion 48 is not disposed inside the insertion hole 70 as shown in FIG. 14. Thus, when the second core wire 12B is inserted into the inside of the second slide portion 42, a front end part of the second core wire 12B hardly comes into contact with the rear end part of the second ceiling wall portion 48. Therefore, the insertion of the second core wire 12B into the inside of the second slide portion 42 is hardly hindered.

[Insertion of First Core Wire into First Slide Portion]

As shown in FIG. 21, with the first terminal 20 accommodated in the accommodating portion 63, a rear end part of the first ceiling wall portion 28 of the first slide portion 22 is disposed to face the locking portion 73 in the front-rear direction. Thus, when the first core wire 12A is inserted into the inside of the first slide portion 22, a front end part of the first core wire 12A hardly comes into contact with the rear end part of the first ceiling wall portion 28. Therefore, the insertion of the first core wire 12A into the inside of the first slide portion 22 is hardly hindered.

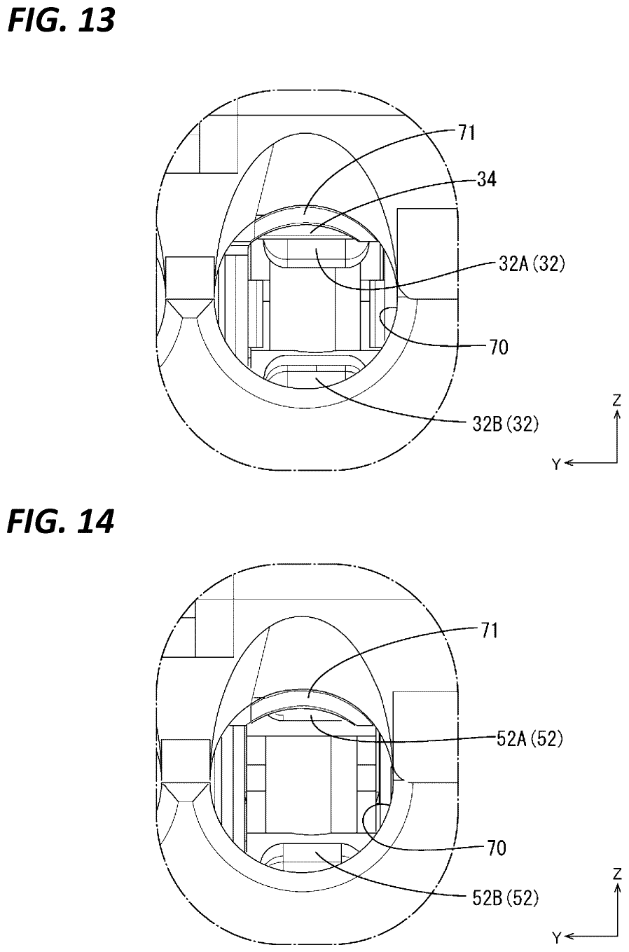

When the insertion hole 70 of the rear holder 62 disposed behind the accommodating portion 63 accommodating the first terminal 20 is viewed from behind, the guide portion 34 is disposed inside the insertion hole 70 as shown in FIG. 13. This is because the interval in the vertical direction between the upper and lower pressing portions 32A, 32B of the first slide portion 22 is smaller than that between the upper and lower pressing portions 52A, 52B of the second slide portion 42 (see FIG. 5). By providing the guide portion 34 in the first slide portion 22, the front end part of the first core wire 12A slides in contact with the guide portion 34, thereby easily entering the inside of the first slide portion 22.

[Insertion of First Core Wire into First Slide Portion according to Comparative Example]

Here, a comparative example not provided with the guide portion 34 unlike this embodiment is considered. As shown in FIG. 23, a third terminal 120 of a connector 110 according to the comparative example is provided with a first slide portion 122 not provided with the guide portion 34, and the other configuration is similar to that of the first terminal 20. With the third terminal 120 accommodated in the accommodating portion 63, a rear end part of a first ceiling wall portion 128 (inner wall portion 128A) is disposed to face the insertion hole 70 in the front-rear direction. Therefore, the insertion of the first core wire 12A into the inside of the first slide portion 122 may be hindered by the front end part of the first core wire 12A coming into contact with the rear end part of the first ceiling wall portion 128 (inner wall portion 128A).

As described above, since the first slide portion 22 is provided with the guide portion 34 in this embodiment, the first core wire 12A hardly comes into contact with the rear end part of the first ceiling wall portion 28 and easily enters the inside of the first slide portion 22.

### [Manufacturing Method of Connector 10]

An example of a manufacturing method of the connector 10 according to this embodiment is described below.

By a known method, the first terminal body 21, the first slide portion 22, the second terminal body 41 and the second slide portion 42 are formed. The first slide portion 22 is assembled with the first terminal body 21 from behind. The front end edge of the first slide portion 22 comes into contact with the locking projections 24A of the first terminal body 21 from behind, and the side wall portions 29 of the first slide portion 22 are expanded and deformed. If the first slide portion 22 is pushed further forward, the side wall portions 29 of the first slide portion 22 are restored and the temporary lock receiving portions 33A of the first slide portion 22 are locked by the locking projections 24A of the first terminal body 21. In this way, the first slide portion 22 is held at the separation position with respect to the first terminal body 21. In this way, the first terminal 20 is obtained (see FIG. 10). The second terminal 40 is also similarly obtained.

The inner housing 61 and the rear holder 62 are formed by injection-molding the synthetic resin. After the first or second terminal 20, 40 is inserted into each accommodating portion 63 of the inner housing 61, the rear holder 62 is assembled with the rear end part of the inner housing 61 from behind. Then, the lock receiving portions 69 of the rear holder 62 ride on the temporary lock portions 68A of the inner housing 61 while being resiliently deformed. If the rear holder 62 is pushed further forward, the lock receiving portions 69 are restored and resiliently locked to the temporary lock portions 68A of the inner housing 61. In this way, the rear holder 62 is held at the temporary locking position with respect to the inner housing 61 (see FIGS. 15 and 18).

In an end part of the first wire 11A, the first core wire 12A is exposed over a predetermined length. The front end part of the first core wire 12A is inserted into the insertion hole 70 disposed behind the accommodating portion 63 accommodating the first terminal 20 from behind. The first core wire 12A is guided into the inside of the first slide portion 22 by the guiding portion 71 of the rear holder 62 and the guide portion 34 and the introducing portions 36 of the first slide portion 22.

If the first wire 11A is pushed further forward, the first core wire 12A enters the inside the first terminal body 21 and is disposed at the position of the sandwiching portion 25 in the front-rear direction. That is, the first core wire 12A passes between the upper and lower connection pieces 25A, 25B (see FIG. 16).

Subsequently, the unillustrated jig is pushed against the jig contact portion 38 from behind, and the first slide portion 22 is moved forward with respect to the first terminal body 21. At this time, the locking of the locking projections 24A of the first terminal body 21 and the temporary lock receiving portions 33A of the first slide portion 22 is released, and the side wall portions 29 of the first slide portion 22 ride on the locking projections 24A and are expanded and deformed.

If the jig contact portion 38 is pushed further forward by the jig, the side wall portions 29 of the first slide portion 22 are restored and the locking projections 24A of the first terminal body 21 and the complete lock receiving portions 33B of the first slide portion 22 are resiliently locked. In this way, the first slide portion 22 is held at the pressing position with respect to the first terminal body 21.

When the first slide portion 22 moves to the pressing position with respect to the first terminal body 21, the upper pressing portion 32A of the first slide portion 22 presses the upper connection piece 25A of the first terminal body 21 downward. Further, the lower pressing portion 32B of the first slide portion 22 presses the lower connection piece 25B of the first terminal body 21 upward. In this way, the first core wire 12A is vertically sandwiched by the upper and lower connection pieces 25A, 25B and the first wire 11A and the first terminal 20 are electrically connected (see FIG. 17).

Also for the second terminal 40, the second core wire 12B is inserted into the second slide portion 42 and the second slide portion 42 is moved forward with respect to the second terminal body 41, similarly to the first terminal 20 (see FIGS. 18 to 20). In this way, the second wire 11B and the second terminal 40 are electrically connected.

Subsequently, if the rear holder 62 is pushed forward, the lock receiving portions 69 of the rear holder 62 ride on the temporary lock portions 68B of the inner housing 61 and are resiliently deformed. If the rear holder 62 is pushed further forward, the complete lock portions 68B and the lock receiving portions 69 are locked. In this way, the rear holder 62 is held at the complete locking position with respect to the inner housing 61 (see FIG. 2). In the above way, the manufacturing of the connector 10 is completed.

### Functions and Effects of Embodiment

According to the embodiment, the following functions and effects are achieved.

The connector 10 according to the embodiment is to be connected to the first wire 11A including the first core wire 12A and extending in the front-rear direction, and provided with the first terminal 20 to be connected to the first core wire 12A and the connector housing 60, into which the first terminal 20 is accommodated and the first wire 11A is inserted. The first terminal 20 includes the first terminal body 21 and the first slide portion 22 slidable in the front-rear direction in a state fit to the first terminal body 21 from outside. The first terminal body 21 includes the sandwiching portion 25 for sandwiching the first core wire 12A. The first slide portion 22 includes the core wire insertion opening 31, through which the first core wire 12A is inserted from behind, the pressing portion 32 for pressing the sandwiching portion 25 against the first core wire 12A inserted through the core wire insertion opening 31, the guide portion 34 disposed in the rear end part of the first slide portion 22 and inclined inward of the first slide portion 22 toward the front and the coupling portion 35 continuously coupling the pressing portion 32 and the guide portion 34 in the front-rear direction. The guide portion 34 is disposed more outward of the first slide portion 22 than the pressing portion 32.

If the diameter of the first core wire 12A is reduced, the first slide portion 22 provided with the pressing portion 32 for pressing the first core wire 12A against the sandwiching portion 25 easily becomes smaller in a direction orthogonal to the front-rear direction. Thus, it may become difficult to insert the first core wire 12A into the inside of the first slide portion 22.

According to the configuration of the embodiment, the guide portion 34 is provided behind the pressing portion 32 via the coupling portion 35. This guide portion 34 is inclined inward of the first slide portion 22 toward the front. Thus, the insertion of the first core wire 12A into the inside of the first slide portion 22 is guided. Further, the guide portion 34 is disposed more outward of the first slide portion 22 than the pressing portion 32. Since the core wire insertion opening 31 is easily made larger in the direction orthogonal to the front-rear direction in this way, the first core wire 12A is easily inserted into the first slide portion 22.

The connector 10 according to the embodiment is to be connected to the second wire 11B including the second core wire 12B and extending in the front-rear direction, and provided with the second terminal 40 to be connected to the second core wire 12B. The diameter of the second core wire 12B is larger than that of the first core wire 12A. The second terminal 40 is accommodated in the connector housing 60, and the second wire 11B is inserted into the connector housing 60. The second terminal 40 includes the second terminal body 41 and the second slide portion 42 slidable in the front-rear direction in a state fit to the second terminal body 41 from outside. The second terminal body 41 includes the sandwiching portion 25 for sandwiching the second core wire 12B. The second slide portion 42 includes the core wire insertion opening 51, through which the second core wire 12B is inserted from behind, and the pressing portion 52 for pressing the second core wire 12B inserted through the core wire insertion opening 51 and disposed at the position of the sandwiching portion 25 in the front-rear direction against the sandwiching portion 25.

According to this configuration, even if the diameter of the second core wire 12B is larger than that of the first core wire 12A, the connector 10 connected to both the first wire 11A including the first core wire 12A and the second wire 11B including the second core wire 12B can be configured without changing the connector housing 60.

In this embodiment, the second terminal body 41 is the first terminal body 21.

According to this configuration, since the first terminal body 21 can be used as the second terminal body 41, the second terminal body 41 may not be newly manufactured. Therefore, the manufacturing cost of the connector 10 can be reduced.

In this embodiment, the first slide portion 22 includes the outer wall portion 28B disposed more outward of the first slide portion 22 than the guide portion 34 and extending in the front-rear direction, the rear end part of the guide portion 34 and that of the outer wall portion 28B are in contact, and the connector housing 60 includes the locking portion 73 facing the rear end part of the outer wall portion 28B in the front-rear direction.

According to this configuration, a locking margin of the rear end part of the first slide portion 22 and the connector housing 60 can be increased by providing the outer wall portion 28B. Further, since the rear end part of the guide portion 34 and that of the outer wall portion 28B are in contact, the deformation of the guide portion 34 due to an external force can be suppressed.

In the embodiment, the first slide portion 22 includes the intermediate wall portions 28C sandwiched by the outer wall portion 28B and the coupling portion 35 and the folded portions 28D continuously connecting the outer wall portion 28B and the intermediate wall portions 28C and folded into a U shape, and the intermediate wall portions 28C are folded in contact with the outer wall portion 28B.

According to this configuration, the first slide portion 22 can be made larger in the direction orthogonal to the front-rear direction by providing the intermediate wall portions 28C. In this way, even if the diameter of the first core wire 12A is small, the first slide portion 22 is easily configured in accordance with the size of the accommodating portion 63 of the connector housing 60 for accommodating the first terminal 20. Therefore, the rattling of the first terminal 20 in the accommodating portion 63 can be suppressed.

In the embodiment, the first slide portion 22 includes the inclined portion 37 formed to be continuous with the front side of the pressing portion 32, and the inclined portion 37 is inclined outward of the first slide portion 22 toward the front and disposed more outward of the first slide portion 22 than the pressing portion 32.

According to this configuration, when the first slide portion 22 is slid forward with respect to the first terminal body 21, the sandwiching portion 25 slides in contact with the inclined portion 37, thereby being easily guided inward of the first slide portion 22 with respect to the pressing portion 32. Thus, the first core wire 12A is easily pressed against the sandwiching portion 25 by the pressing portion 32.

In the embodiment, the connector housing 60 is provided with the inner housing 61 for accommodating the first terminal 20 and the rear holder 62 to be assembled with the rear part of the inner housing 61, the first wire 11A being inserted into the rear holder 62. The rear holder 62 is locked to the inner housing 61 at either one of the temporary locking position and the complete locking position disposed forward of the temporary locking position, and can be locked at the complete locking position with the first core wire 12A pressed against the sandwiching portion 25 by the pressing portion 32.

According to this configuration, the connector 10 can be made smaller in the front-rear direction with the first core wire 12A pressed against the sandwiching portion 25 by the pressing portion 32.

### Other Embodiments

(1) Although the connector 10 is provided with the first terminal 20 to be connected to the first wire 11A and the second terminal 40 to be connected to the second wire 11B in the above embodiment, there is no limitation to this and a connector may not be provided with a second terminal to be connected to a second wire (see FIG. 17).
(2) Although the second terminal body 41 is the first terminal body 21 in the above embodiment, there is no limitation to this and a second terminal body may be different from a first terminal body.
(3) Although the first slide portion 22 includes the introducing portions 36 in the above embodiment, there is no limitation to this and a first slide portion may include no introducing portion.

### LIST OF REFERENCE NUMERALS

10: connector
11A: first wire
11B: second wire
12A: first core wire
12B: second core wire
13A: first insulation coating
13B: second insulation coating
20: first terminal
21: first terminal body
22: first slide portion
22A: front tube portion
22B: rear tube portion
23: connecting tube portion
23A: locking lance
23B: resilient locking piece
24: base portion
24A: locking projection
25: sandwiching portion
25A: upper connection piece
25B: lower connection piece
26A: upper holding protrusion
26B: lower holding protrusion
27: bottom wall portion
28: first ceiling wall portion
28A: inner wall portion
28B: outer wall portion
28C: intermediate wall portion
28D: folded portion
29: side wall portion
29A: first side wall portion
29B: second side wall portion
30A: locking protrusion
30B: locking recess
30C: bent portion
31: core wire insertion opening
32: pressing portion
32A: upper pressing portion
32B: lower pressing portion
33A: temporary lock receiving portion
33B: complete lock receiving portion
34: guide portion
35 coupling portion
36: introducing portion
37: inclined portion
38: jig contact portion
40: second terminal
41 second terminal body
42: second slide portion
42A: front tube portion
42B: rear tube portion
47: bottom wall portion
48: second ceiling wall portion
48A: inner wall portion
48B: outer wall portion
49: side wall portion
49A: first side wall portion
49B: second side wall portion
50A: locking protrusion
50B: locking recess
50C: bent portion
51: core wire insertion opening
52 pressing portion
52A: upper pressing portion
52B: lower pressing portion
53A: temporary lock receiving portion
53B: complete lock receiving portion
57: inclined portion
58: jig contact portion
60: connector housing
61: inner housing
62: rear holder
63: accommodating portion
64: lance receiving portion
65: front stop portion
66: separation wall
67: partition wall
68A: temporary lock portion
68B: complete lock portion
69: lock receiving portion
70: insertion hole
71: guiding portion
72: receptacle
73: locking portion
74 separation wall receiving portion
110: connector according to comparative example
120: third terminal
122: first slide portion
128: first ceiling wall portion
128A: inner wall portion

1. A connector to be connected to a first wire including a first core wire and extending in a front-rear direction, comprising:
a first terminal to be connected to the first core wire; and
a connector housing for accommodating the first terminal, the first wire being inserted into the connector housing,
the first terminal including a first terminal body and a first slide portion slidable in the front-rear direction in a state fit to the first terminal body from outside,
the first terminal body including a sandwiching portion for sandwiching the first core wire,
the first slide portion including:
a core wire insertion opening, the first core wire being inserted through the core wire insertion opening from behind;
a pressing portion for pressing the sandwiching portion against the first core wire inserted through the core wire insertion opening;
a guide portion disposed in a rear end part of the first slide portion, the guide portion being inclined inward of the first slide portion toward front; and
a coupling portion continuously coupling the pressing portion and the guide portion in the front-rear direction, and
the guide portion being disposed more outward of the first slide portion than the pressing portion.

2. The connector of claim 1 to be connected to a second wire including a second core wire and extending in the front-rear direction, comprising a second terminal to be connected to the second core wire, wherein:
a diameter of the second core wire is larger than a diameter of the first core wire,
the second terminal is accommodated into the connector housing,
the second wire is inserted into the connector housing,
the second terminal includes a second terminal body and a second slide portion slidable in the front-rear direction in a state fit to the second terminal body from outside,
the second terminal body includes a sandwiching portion for sandwiching the second core wire, and
the second slide portion includes:
a core wire insertion opening, the second core wire being inserted through the core wire insertion opening from behind; and
a pressing portion for pressing the second core wire inserted through the core wire insertion opening and disposed at a position of the sandwiching portion in the front-rear direction against the sandwiching portion.

3. The connector of claim 2, wherein the second terminal body is the first terminal body.

4. The connector of claim 13, wherein:
the first slide portion includes an outer wall portion disposed more outward of the first slide portion than the guide portion and extending in the front-rear direction,
a rear end part of the guide portion and a rear end part of the outer wall portion are in contact, and
the connector housing includes a locking portion facing the rear end part of the outer wall portion in the front-rear direction.

5. The connector of claim 4, wherein:
the first slide portion includes an intermediate wall portion sandwiched by the outer wall portion and the coupling portion and a folded portion continuously connecting the outer wall portion and the intermediate wall portion and folded into a U shape, and
the intermediate wall portion is folded in contact with the outer wall portion.

6. The connector of claim 1, wherein:
the first slide portion includes an inclined portion formed to be continuous with a front side of the pressing portion, and
the inclined portion is inclined outward of the first slide portion toward the front and disposed more outward of the first slide portion than the pressing portion.

7. The connector of claim 1, wherein:
the connector housing includes an inner housing for accommodating the first terminal and a rear holder to be assembled with a rear part of the inner housing, the first wire being inserted into the rear holder,
the rear holder is locked to the inner housing at either one of a temporary locking position and a complete locking position disposed forward of the temporary locking position, and
the rear holder is lockable at the complete locking position with the first core wire pressed against the sandwiching portion by the pressing portion.
